(19) United States
(12) Patent Application Publication
(10) Pub. No.: US 2017/0095759 A1
(43) Pub. Date: Apr. 6, 2017

(54) Liquid Filter and Drain

(71) Applicant: Caterpillar Inc., Peoria, IL (US)

(72) Inventor: Kevin L. Martin, Washburn, IL (US)

(73) Assignee: Caterpillar Inc., Peoria, IL (US)

(21) Appl. No.: 14/874,299

(22) Filed: Oct. 2, 2015

(51) Int. Cl. B01D 35/16; F02M 37/22; B01D 35/30; B01D 35/00

(52) U.S. Cl. CPC B01D 35/16; B01D 35/005; F02M 37/22; B01D 35/30; B01D 2201/167; B01D 2201/304

(57) ABSTRACT

A filter unit includes a top plate, a bottom plate, and a filter medium. The top plate is disposed at a first end of the filter unit. The bottom plate is disposed at a second end of the filter unit. The bottom plate includes a threaded filter portion and a valve shaft. The threaded filter portion has external threads and the valve shaft extends from the threaded filter portion along an axis of elongation of the filter unit. The filter medium is disposed between the top plate and the bottom plate.

### TECHNICAL FIELD

This patent disclosure relates generally to a liquid filter and, more particularly, to a filter and drain for the liquid filter housing.

### BACKGROUND

It is generally known that engines typically include a filter, such as a fuel filter in a filter housing and the filter may be periodically inspected or replaced. In order to remove the fuel from the filter housing for inspection or to remove any accumulated contaminants, the filter housing may include a drain. The drain may be used to facilitate collecting the fuel from the filter housing to reduce spillage and ease cleanup. For example, a hose may attach to the drain to convey the fuel to a collection container.

The drain is typically disposed at the bottom of the filter housing and opened via some type of threaded opening. It is common for the drain to thread into the bottom of filter and so, the filter and drain may be thought of as a sub-assembly in the filter housing. However, while the filter is replaced at service intervals, the drain is not and over time and with repeated use, the drain may become worn so that the threads or seals no longer function properly. Historically, the drain and the seals on the drain are not serviced unless there in an evident leak. In addition, some drains are non-removable or not easily removed for servicing. Furthermore, drains typically have external threads that may be damaged during servicing.

U.S. Pat. No. 8,845,897 (hereinafter “the '897 patent”), entitled “Drain Valve for Filter Service and Method,” purports to describe a removable drain valve assembly. However, the drain valve assembly of the '897 patent includes threads that may be damaged during servicing and does not provide seals that are automatically replaced at the same time the filter is replaced. As such, some amount of leakage may occur with the drain valve assembly of the '897 patent before the drain valve assembly is serviced.

Accordingly, there is a need for an improved liquid filter and drain to address the problems described above and/or problems posed by other conventional approaches.

### SUMMARY

The foregoing needs are met, to a great extent, by the present disclosure, wherein aspects of an improved liquid filter and drain are provided.

In one aspect, the disclosure describes a filter unit. The filter unit includes a top plate, a bottom plate, and a filter medium. The top plate is disposed at a first end of the filter unit. The bottom plate is disposed at a second end of the filter unit. The bottom plate includes a threaded filter portion and a valve shaft. The threaded filter portion has external threads and the valve shaft extends from the threaded filter portion along an axis of elongation of the filter unit. The filter medium is disposed between the top plate and the bottom plate.

In another aspect, the disclosure describes a drain valve assembly includes a bottom plate and a valve stem. The bottom plate has a threaded filter portion, a valve shaft, and a valve shaft seal. The threaded filter portion has a set of external threads. The valve shaft extends from the threaded portion. The valve shaft seal is disposed annularly about at a distal end of the valve shaft. The valve stem has a threaded stem portion, an axial passage, a valve stem inlet, and a valve stem outlet. The threaded stem portion is disposed at a first end of the valve stem. The threaded stem portion includes a set of internal threads configured to mate with the threaded filter portion. The axial passage extends along a central axis of the valve stem. The valve stem inlet extends from an outside surface of the valve stem to the axial passage. The valve stem outlet is disposed at a second end of the valve stem. The valve shaft seal is configured to slide within the axial passage. The drain valve assembly defines a closed configuration when the valve shaft seal is disposed between the valve stem inlet and the valve stem outlet. The drain valve assembly defines an open configuration when the valve stem inlet is disposed between the valve shaft seal and the valve stem outlet.

In yet another aspect, the disclosure describes a housing assembly configured to filter a fluid. The filter housing assembly includes a filter unit and a drain valve assembly. The filter unit includes a top plate, a bottom plate, and a filter medium disposed between the top plate and the bottom plate. The top plate is disposed at a first end of the filter unit. The top plate includes a fluid outlet and a plurality of stepped spokes extending outwardly from a perimeter of the top plate. The bottom plate is disposed at a second end of the filter unit. The bottom plate includes a threaded filter portion, a valve shaft, and a valve shaft seal. The threaded filter portion has a set of external threads. The valve shaft extending from the threaded filter portion along an axis of elongation of the filter unit. The valve shaft seal is disposed annularly about at a distal end of the valve shaft. The drain valve assembly includes a valve stem having a threaded stem portion, an axial passage, a valve stem inlet, and a valve stem outlet. The threaded stem portion is disposed at a first end of the valve stem. The threaded stem portion includes a set of internal threads configured to mate with the threaded filter portion. The axial passage extends along a central axis of the valve stem. The valve stem inlet extends from an outside surface of the valve stem to the axial passage. The valve stem outlet is disposed at a second end of the valve stem. The valve shaft seal is configured to slide within the axial passage. The drain valve assembly defines a closed configuration when the valve shaft seal is disposed between the valve stem inlet and the valve stem outlet. The drain valve assembly defines an open configuration when the valve stem inlet is disposed between the valve shaft seal and the valve stem outlet.

It will be understood that the disclosure is not limited in its application to the details of construction and to the arrangements of the components set forth in the following description or illustrated in the drawings. The disclosed device and method are capable of aspects in addition to those described and the disclosed method is capable of being practiced and carried out in various ways. Also, it will be understood that the terminology employed herein, as well as the abstract, are for the purpose of description and should not be regarded as limiting.

Those skilled in the art will appreciate that the conception upon which this disclosure is based may readily be utilized as a basis for the designing of other structures, methods and systems for carrying out the several purposes of the various aspects. Therefore, the claims will be regarded as including such equivalent constructions insofar as they do not depart from the spirit and scope of the various aspects.

### BRIEF DESCRIPTION OF THE DRAWINGS

FIG. 1 illustrates an exemplary machine, according to an aspect of the disclosure.

FIG. 2 is a cross-sectional view taken axially through a filter housing assembly with a drain assembly in a closed configuration, according to an aspect of the disclosure.

FIG. 3 is a cross-sectional view taken axially through a portion of the filter housing assembly with the drain valve assembly in a closed configuration, according to an aspect of the disclosure.

FIG. 4 is a cross-sectional view taken axially through a portion of the filter housing assembly with the drain valve assembly in an open configuration, according to an aspect of the disclosure.

FIG. 5 is a cross-sectional perspective view taken axially through a valve stem of the filter housing assembly, according to an aspect of the disclosure.

FIG. 6 is a cross-sectional view taken axially through the valve stem of the filter housing assembly, according to an aspect of the disclosure.

FIG. 7 is a cross-sectional view taken axially through the valve stem of the filter housing assembly, according to an aspect of the disclosure.

FIG. 8 is a cross-sectional perspective view taken axially through the filter housing assembly at a stage in assembly of the filter housing assembly, according to an aspect of the disclosure.

FIG. 9 is a cross-sectional perspective view taken axially through the filter housing assembly at another stage in assembly of the filter housing assembly, according to an aspect of the disclosure.

FIG. 10 is a cross-sectional perspective view taken axially through the filter housing assembly at another stage in assembly of the filter housing assembly, according to an aspect of the disclosure.

FIG. 11 is a cross-sectional perspective view taken axially through the filter housing assembly at another stage in assembly of the filter housing assembly, according to an aspect of the disclosure.

The drawings presented are intended solely for the purpose of illustration and therefore, are neither desired nor intended to limit the subject matter of the disclosure to any or all of the exact details of construction shown, except insofar as they may be deemed essential to the claims.

### DETAILED DESCRIPTION

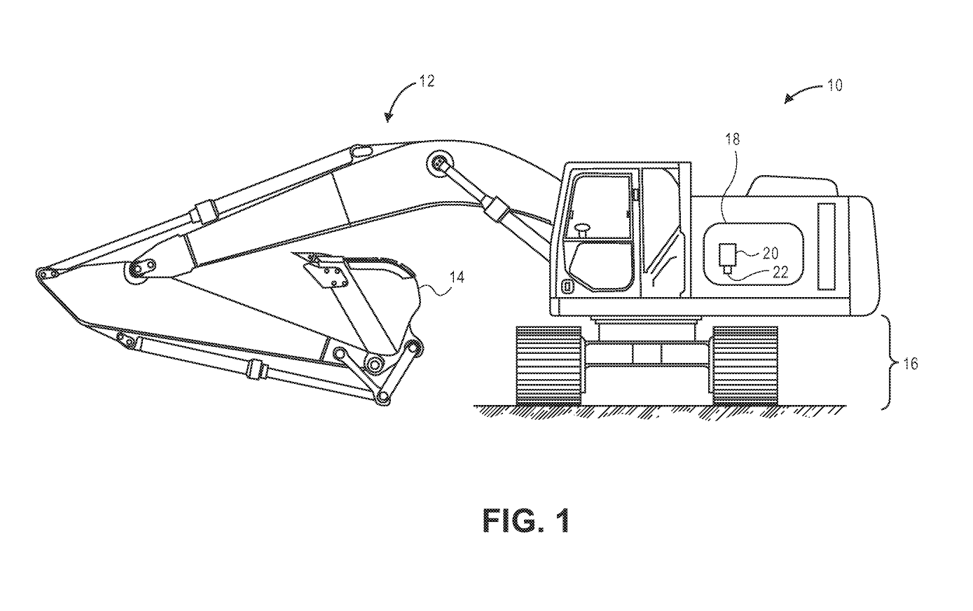

FIG. 1 illustrates an exemplary machine 10 having various systems and components that cooperate to accomplish a task. The machine 10 may embody a fixed or mobile machine that performs some type of operation associated with an industry such as mining, construction, farming, transportation, power generation, or another industry known in the art. For example, the machine 10 may be an earth moving machine such as an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18.

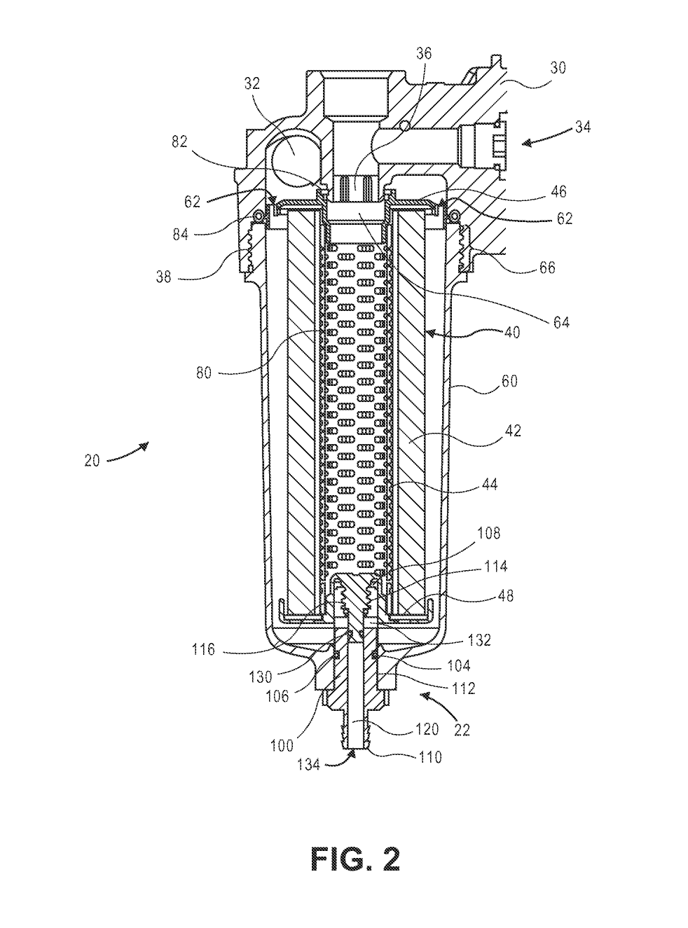

In a particular example, the power source 18 includes an engine configured to combust a fuel such as diesel and the fuel is filtered at a filter housing assembly 20. As fuel passes through the filter housing assembly 20, contaminants such as particulates, debris, water, and the like are filtered out and retained in a filter medium (shown in FIG. 2) and/or collected in the filter housing assembly 20. Periodically, the filter medium and/or fluid in the filter housing assembly 20 may be inspected. When replacing the filter medium, the fuel and the contaminants are drained from the filter housing assembly 20 at a drain valve assembly 22. For the purpose of this disclosure, the term ‘fluid’ will be used throughout to describe these contaminants, waste fluid, or contaminants suspended in fluid that are being removed from within the filter housing assembly 20. Of note, while particular example is made throughout of filtering and separating particulates and water from fuel, the various embodiments are not limited to filtering and collecting water from fuel, but rather, include any suitable filtering application in which the housing includes a drain. Examples of suitable filtering applications include hydraulic, lubricant, air, or other such filtration systems. Moreover, the drain valve assembly 22 may be utilized to remove standing fluid residing in the filter housing assembly 20 prior to the filter housing assembly 20 being removed from the filter base (shown in FIG. 2) to replace the filter medium.

FIG. 2 is a cross-sectional view taken axially through a filter base 30 and the filter housing assembly 20 with the drain valve assembly 22 in a closed configuration, according to an aspect of the disclosure. As shown in FIG. 2, the filter base 30 includes a base inlet 32, base outlet 34, a connection port 36, and a housing coupler 38. A filter unit 40 is installed in the filter housing assembly 20. The filter unit 40 includes a filter medium 42 disposed about a center tube 44 and the filter medium 42 is disposed between a top plate 46 and a bottom plate 48. The filter medium 42 may include any suitable material for filtering fluids such as air, fuel, and/or oil. Examples of suitable materials include: paper or other natural material; spun, felted, or woven natural or man-made fibers; polymer foams; and the like. In a particular example, the filter medium 42 includes a card stock of felted polyester fibers. This card stock can be cut, scored, folded and able to retain folds. In particular, the card stock of the filter medium 42 folded into pleats and is wrapped around the center tube 44.

The filter housing assembly 20 includes a housing 60, a fuel inlet 62, a fuel outlet 64, a base coupler 66 and the drain valve assembly 22. In general, the housing 60 may include any suitable material such as, for example, metals, plastics, elastomers, and the like. In a particular example, the housing 60 is primarily sheet metal formed into a cylindrical shell and incorporating elastomeric seals. In another particular example, the housing 60 is a cast metal shell to which machined surfaces are subsequently milled and/or elastomeric seals are later added.

The fuel inlet 62 is in fluid communication with the base inlet 32 and disposed annularly about the perimeter of the top plate 46 (shown particularly in FIG. 11). The fuel inlet 62 is configured to direct the fuel to a first side of the filter medium 42. In the example shown more clearly in FIG. 11, the fuel inlet 62 is a series of openings disposed about the perimeter of the top plate 46. As shown by the arrows indicating flow of the fuel, the fuel is directed towards the perimeter of the housing 60 and then through the filter medium 42 towards an interior chamber 80. Thereafter, the fuel flows out the fuel outlet 64. The fuel outlet 64 is disposed in the housing 60 and configured to receive the fuel from a second side of the filter medium 42. The fuel outlet 64 includes an outlet seal 82 configured to mate and form a seal with the connection port 36. To generate a seal and prevent or reduce leaks between the filter base 30 and the filter housing assembly 20, a gasket 84 disposed about the fuel inlet 62. In the example shown more clearly in FIGS. 9-11, the gasket 84 is secured to a ring coupler 86. In response to the housing 60 being secured to the filter base 30, the gasket 84 is secured in place and prevented from turning. The ring coupler 86 in turn, is configured to mate with the top plate 46 as again shown in FIGS. 9-11. In this manner, the filter unit 40 may be secured from rotating within the housing 60.

The drain valve assembly 22 is disposed at a lower portion of the housing 60 to drain the fluid separated from the fuel out of the housing 60. The drain valve assembly 22 is disposed in a housing bore 90. The housing bore 90 is defined by a cylindrical wall 92 passing through the housing 60. The drain valve assembly 22 includes a valve stem 100 and a lower seal 102. The cylindrical wall 92 is sufficiently smooth and long enough to slidingly seal with the lower seal 102 disposed on a valve stem 100 of the drain valve assembly over the travel of the valve stem 100 from the closed configuration to an open position. The lower seal 102 includes any suitable type of seal such as, for example, a friction fit, O-ring seal, or the like. In a particular example, the lower seal 102 includes an annular groove 104 disposed about the valve stem 100 and sized to accept an O-ring 106. The O-ring 106 may include any suitable elastomeric or deformable material.

The valve stem 100 is generally sized to mate with the housing bore 90 at a relatively close tolerance while allowing rotation and/or a sliding motion of the valve stem 100 within the housing bore 90. The valve stem 100 has a first end 108, a second end 110 and a body 112. The first end 108 is disposed within the housing 60 and includes a threaded stem portion 114 configured to mate with a corresponding threaded filter portion 116. The threaded stem portion 114 includes internal threads that are disposed within a portion of an axial passage 120. The axial passage 120 extends through the body 112 from the first end 108 to the second end 110.

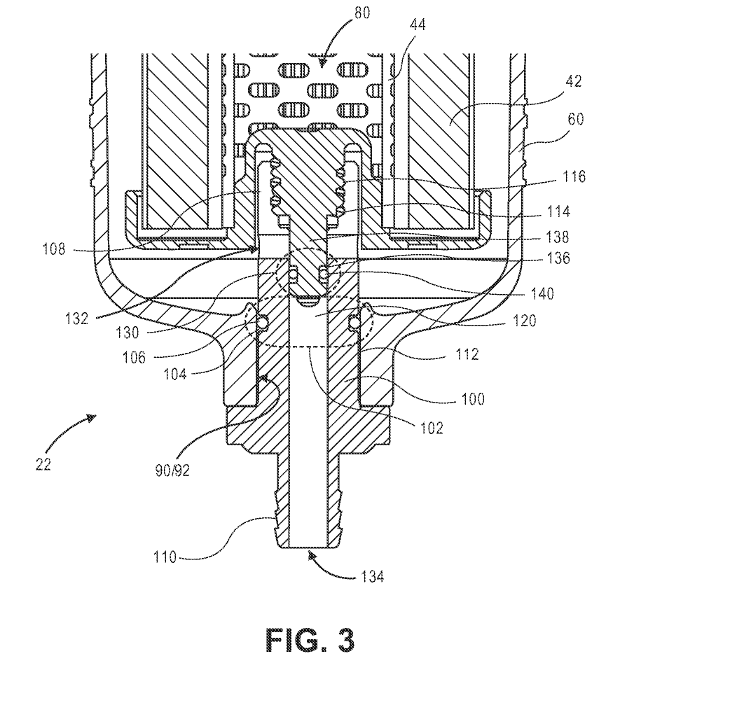

The drain valve assembly 22 is shown in the closed configuration in FIGS. 2 and 3. In general, the closed configuration seals the drain valve assembly 22 to allow for the normal filtering operation of filter housing assembly 20 and the operation of the power source 18 shown in FIG. 1. The closed configuration may be accomplished in any suitable manner. In the particular example shown in FIG. 2, the closed configuration is accomplished in response to the threaded filter portion being mated (e.g., threaded into) with the threaded stem portion 114 and an internal seal 130 forming a seal within the axial passage 120 and the seal is between a valve stem inlet 132 and a valve stem outlet 134. The internal seal 130 may be configured to reduce or stop a flow of fluid from the valve stem inlet 132 to the valve stem outlet 134 when in the closed configuration. Again, this internal seal 130 may be accomplished in any suitable manner. In the particular example shown, an annular groove 136 is disposed about a valve shaft 138 extending along an axis of elongation of the filter unit 40 from the threaded filter portion 116. In a more particular example, the valve shaft 138 may extend along a central axis of the filter unit 40 and the valve shaft 138 is sized to fit within the axial passage 120 and the annular groove 136 is sized to accept an O-ring 140. The O-ring 140 is configured to form a seal when compressed between the annular groove 136 and an internal surface of the axial passage 120.

FIG. 3 is a cross-sectional view taken axially through a portion of the filter housing assembly 20 with the drain valve assembly 22 in a closed configuration, according to an aspect of the disclosure. As shown in FIG. 3, the valve stem 100 is configured to slide within the housing bore 90 and this movement causes a corresponding sliding movement of the valve shaft 138 within the axial passage 120. In the shown closed configuration, the internal seal 130 is disposed between the valve stem inlet 132 and the valve stem outlet 134 to seal the drain valve assembly 22 in the closed configuration.

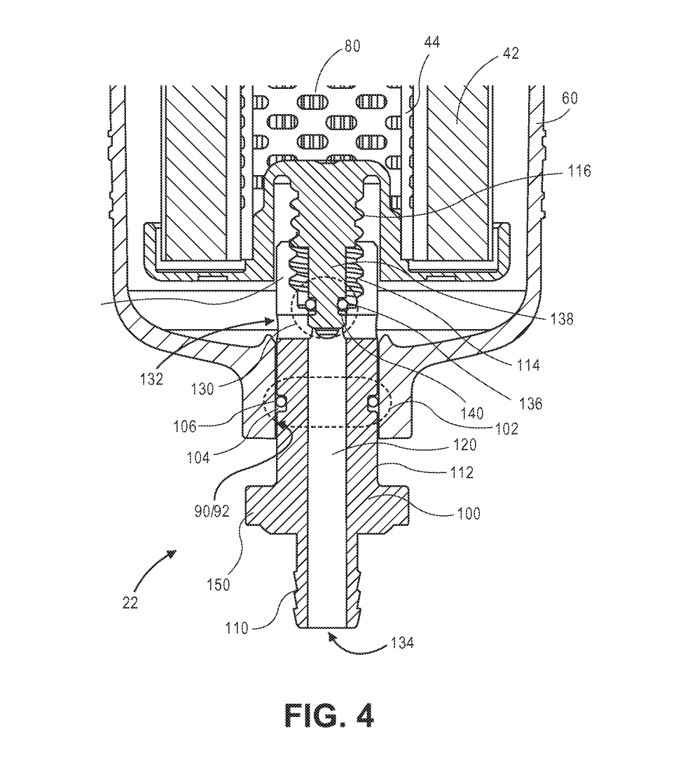

FIG. 4 is a cross-sectional view taken axially through a portion of the filter housing assembly 20 with the drain valve assembly 22 in an open configuration, according to an aspect of the disclosure. As shown in FIG. 4, the valve stem 100 is configured to slide within the housing bore 90 and this movement causes a corresponding sliding movement of the valve shaft 138 within the axial passage 120. In the shown open configuration, the valve stem inlet 132 is disposed between the internal seal 130 and the valve stem outlet 134. That is, the internal seal 130 is moved upstream of the valve stem inlet 132 to open the drain valve assembly 22 to the flow of fluid.

In order to move the valve stem 100 from the closed configuration shown in FIG. 3 to the open configuration shown in FIG. 4, the valve stem 100 may be rotated to unthread the threaded stem portion 114 from the threaded filter portion 116. In this regard, the valve stem 100 may include a knob 150 to facilitate grasping and applying torque to the valve stem 100.

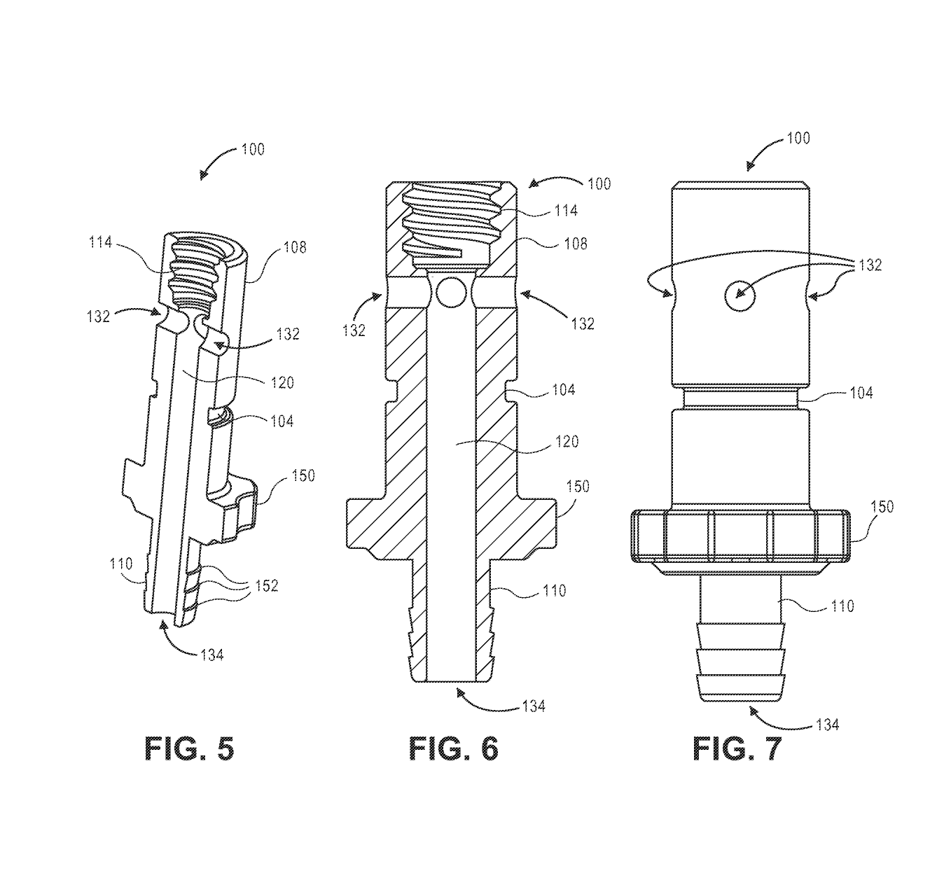

FIGS. 5-7 are various views of the valve stem 100 of the filter housing assembly 20, according to an aspect of the disclosure. As shown in FIGS. 5-7, the valve stem 100 may include one or more barbs 152 or other such structure such as ridges, grooves, or the like configured to secure a hose (not shown) thereto. In this manner, outflow from the filter housing assembly 20 may be collected or otherwise conveyed away.

Also shown in FIGS. 5-7, the valve stem inlet 132 may include a plurality of inlets. In the example shown, the valve stem inlet 132 may include cross bores that intersect at the axial passage 120. In other examples, the valve stem inlet 132 may include a single inlet, two inlets, or more.

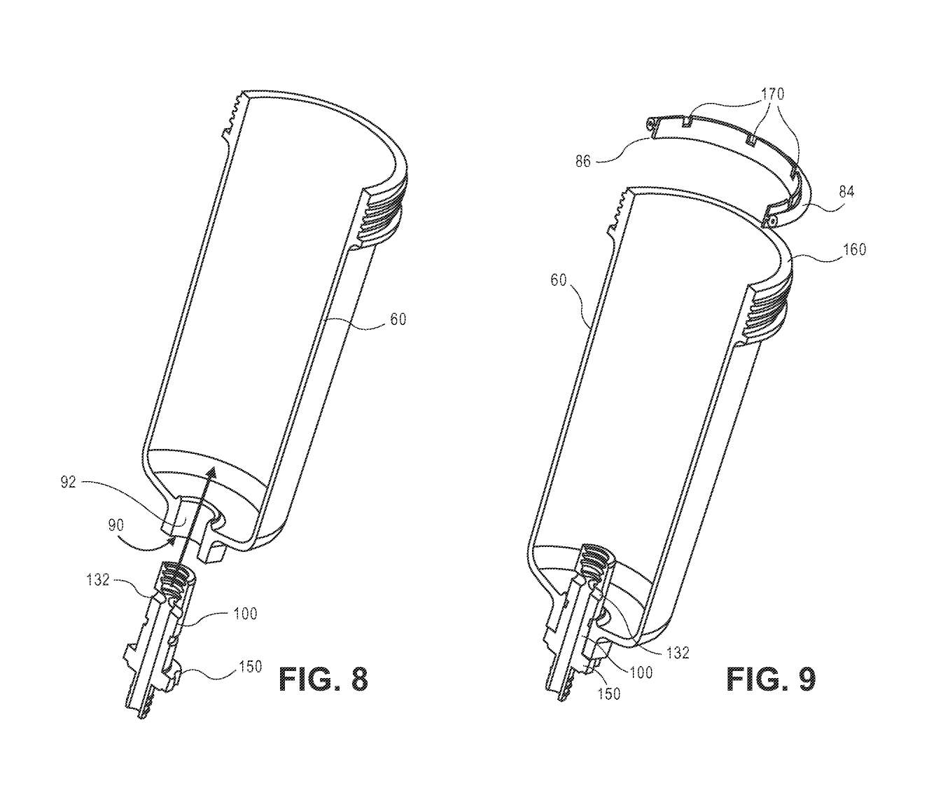

FIGS. 8-11 are cross-sectional perspective views taken axially through the filter housing assembly 20 at various stages in assembly of the filter housing assembly 20, according to an aspect of the disclosure. As shown in FIG. 8, the valve stem 100 is inserted into the housing 60 via the housing bore 90. In another example, the valve stem 100 may inserted down through the housing 60 and out the housing bore 90 by having the knob 150 be a detachable component of the valve stem 100 that is affixed after insertion. In this example, the valve stem 100 may include a stop (not shown) disposed just below the valve stem inlet 132 and the stop can be configured to prevent the valve stem 100 from being withdrawn from the housing bore 90.

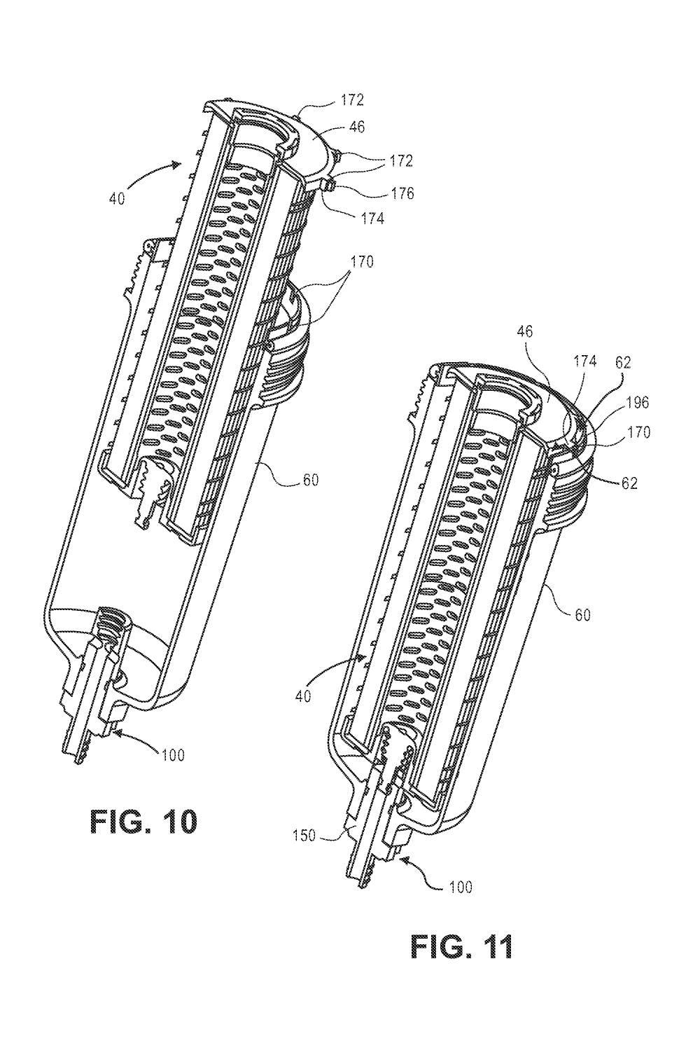

As shown in FIG. 9, the ring coupler 86 with the gasket 84 affixed thereto are place on a rim 160 of the housing 60. As discussed with reference to FIG. 2, the gasket 84 is secured and prevented from rotating in response to the housing 60 being secured to the filter base 30. This results in the ring coupler 86 being secured as well. The ring coupler 86 includes a plurality of notches 170. As shown in FIG. 10, the top plate 46 includes a plurality of stepped spokes 172 corresponding to the notches 170. The stepped spokes 172 extend laterally from the top plate 46. Each of the stepped spokes 172 includes a spoke base 174 and a spoke tip 176. As shown in FIG. 11, the spoke tip 176 is configured to fit into the respective notch 170 and the spoke base 174 is configured to rest upon an inside surface of the ring coupler 86 to center the top plate 46 and therefore the filter unit 40 within the housing 60. Also shown in FIG. 11, the fuel inlet 62 is defined by the plurality of stepped spokes 172, an outside perimeter surface of the top plate 46, and an inside surface of the ring coupler 86.

### INDUSTRIAL APPLICABILITY

The present disclosure may be applicable to any machine including a fluid filter. Aspects of the disclosed filter housing assembly may promote ease of use, reduced manufacturing costs, reduced waste in the manufacturing process, operational flexibility, and performance of fluid filter housing assemblies in general and fuel systems in particular. As described herein, it is an advantage of aspects of the filter housing assembly 20 that the top plate 46 is a separate piece from the ring coupler 86. For example, the gasket 84 is over-molded on the ring coupler 86. This process entails first forming the ring coupler 86 and then placing the ring coupler 86 into a second mold in which the gasket 84 is molded and integrated onto the ring coupler 86. It is more likely that an over-molded component will be rejected during quality control because of the additional steps in the manufacturing process. Also, over-molded components are more difficult to recycle due to the two different materials. By making the ring coupler 86 separate from the top plate 46, if the ring coupler 86 is rejected, only a relatively low-mass component is rejected and so, material cost can be saved.

It is another advantage of some aspects of the disclosure, that the valve stem 100 may be formed as a single piece. In this manner, the number of components in the filter housing assembly 20 may be reduced. In addition, Applicant discovered that the O-ring 106 shown in FIG. 2 is easily inspected and replaced if needed by withdrawing the valve stem 100 from the housing 60 (for example, while servicing the filter unit 40) In contrast, in conventional valve stems, the O-rings are typically located in an area that is inaccessible because the valve stem is captured between a stop block and the knob.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Throughout the disclosure, like reference numbers refer to similar elements herein, unless otherwise specified.

We claim:

1. A filter unit comprising:
a top plate disposed at a first end of the filter unit;
a bottom plate disposed at a second end of the filter unit, the bottom plate including a threaded filter portion and a valve shaft, the threaded filter portion having external threads and the valve shaft extending from the threaded filter portion along an axis of elongation of the filter unit; and
a filter medium disposed between the top plate and the bottom plate.

2. The filter unit according to claim 1, further comprising:
a valve shaft seal disposed annularly about the valve shaft and configured to form a seal with an inside surface of a valve stem.

3. The filter unit according to claim 1, further comprising:
a fluid outlet to convey a fluid through the top plate and the fluid outlet being defined by an inside surface;
a plurality of stepped spokes extending outwardly from a perimeter of the top plate; and
a ring coupler configured to couple the filter unit to a housing, the ring coupler including a plurality of notches disposed about a perimeter of the ring coupler and configured to mate with the plurality of stepped spokes.

4. The filter unit according to claim 3, further comprising:
a plurality of fluid inlets disposed about the top plate and defined by the plurality of stepped spokes, an outside perimeter surface of the top plate, and an inside surface of the ring coupler.

5. The filter unit according to claim 3, further comprising:
a gasket secured about the perimeter of the ring coupler.

6. The filter unit according to claim 3, further comprising:
an outlet seal disposed annularly about an inside surface of the fluid outlet and configured to form a seal about an outside surface of a connection port from a filter base.

7. A drain valve assembly comprising:
a bottom plate having:
a threaded filter portion with a set of external threads;
a valve shaft extending from the threaded filter portion; and
a valve shaft seal disposed annularly about at a distal end of the valve shaft; and
a valve stem having:
a threaded stem portion disposed at a first end of the valve stem, the threaded stem portion including a set of internal threads configured to mate with the threaded filter portion;
an axial passage extending along a central axis of the valve stem;
a valve stem inlet extending from an outside surface of the valve stem to the axial passage;
a valve stem outlet disposed at a second end of the valve stem; and
wherein the valve shaft seal is configured to slide within the axial passage, the drain valve assembly defining a closed configuration when the valve shaft seal is disposed between the valve stem inlet and the valve stem outlet, the drain valve assembly defining an open configuration when the valve stem inlet is disposed between the valve shaft seal and the valve stem outlet.

8. The drain valve assembly according to claim 7, further comprising:
a knob coupled to the valve stem and configured to transmit torque to the valve stem to turn the valve stem.

9. The drain valve assembly according to claim 7, further comprising:
a body having an outside surface configured to move telescopically within a housing bore of a filter housing assembly.

10. The drain valve assembly according to claim 9, further comprising:
a valve stem seal disposed about the valve stem and configured to form a seal between the body and the housing bore.

11. The drain valve assembly according to claim 7, wherein the valve stem inlet includes a plurality of valve stem inlets.

12. A housing assembly configured to filter a fluid, the filter housing assembly comprising:
a filter unit including:
a top plate disposed at a first end of the filter unit, the top plate including a fluid outlet and a plurality of stepped spokes extending outwardly from a perimeter of the top plate;
a bottom plate disposed at a second end of the filter unit, the bottom plate including:
a threaded filter portion with a set of external threads;
a valve shaft extending from the threaded filter portion along an axis of elongation of the filter unit; and
a valve shaft seal disposed annularly about at a distal end of the valve shaft; and
a filter medium disposed between the top plate and the bottom plate; and
a drain valve assembly including:
a valve stem having:
a threaded stem portion disposed at a first end of the valve stem, the threaded stem portion including a set of internal threads configured to mate with the threaded filter portion;
an axial passage extending along a central axis of the valve stem;
a valve stem inlet extending from an outside surface of the valve stem to the axial passage;
a valve stem outlet disposed at a second end of the valve stem; and
wherein the valve shaft seal is configured to slide within the axial passage, the drain valve assembly defining a closed configuration when the valve shaft seal is disposed between the valve stem inlet and the valve stem outlet, the drain valve assembly defining an open configuration when the valve stem inlet is disposed between the valve shaft seal and the valve stem outlet.

13. The housing assembly according to claim 12, further comprising:
a ring coupler configured to couple the filter unit to a housing, the ring coupler including a plurality of notches disposed about a perimeter of the ring coupler and configured to mate with the plurality of stepped spokes.

14. The housing assembly according to claim 13, further comprising:
a plurality of fluid inlets disposed about the top plate and defined by the plurality of stepped spokes, an outside perimeter surface of the top plate, and an inside surface of the ring coupler.

15. The housing assembly according to claim 13, further comprising:
a gasket secured about the perimeter of the ring coupler.

16. The housing assembly according to claim 12, further comprising:
an outlet seal disposed annularly about an inside surface of the fluid outlet and configured to form a seal about an outside surface of a connection port from a filter base.

17. The housing assembly according to claim 12, further comprising:
a valve shaft seal disposed annularly about the valve shaft and configured to form a seal with an inside surface of the valve stem.

18. The housing assembly according to claim 12, further comprising:
a knob coupled to the valve stem and configured to transmit torque to the valve stem to turn the valve stem.

19. The housing assembly according to claim 12, further comprising:
a body having an outside surface configured to telescope within a housing bore of a filter housing assembly.

20. The housing assembly according to claim 19, further comprising:
a valve stem seal disposed about the valve stem and configured to form a seal between the body and the housing bore.
